(19) United States
(12) Patent Application Publication
(10) Pub. No.: US 2026/0323188 A1
(43) Pub. Date: Oct. 15, 2026

(54) PHOTOELECTRIC CONVERSION APPARATUS, CONTROL METHOD FOR PHOTOELECTRIC CONVERSION APPARATUS, PROGRAM, AND STORAGE MEDIUM

(71) Applicant: CANON KABUSHIKI KAISHA, Tokyo (JP)

(72) Inventor: NAOKI ISHIKAWA, Chiba (JP)

(21) Appl. No.: 19/636,279

(22) Filed: Apr. 1, 2026

(30) Foreign Application Priority Data
Apr. 14, 2025 (JP) 2025-066286

(51) Int. Cl. H04N 25/76; H04N 25/773; H04N 25/78

(52) U.S. Cl. CPC H04N 25/7795; H04N 25/773; H04N 25/78

(57) ABSTRACT

An apparatus includes a conversion portion configured to generate a detection signal by avalanche multiplication, a counter circuit configured to count a signal that is based on the detection signal output from the conversion portion, a read-out circuit configured to read out a count value obtained by the counter circuit, the read-out circuit being capable of reading out the count value at a plurality of timings in an accumulation period for one frame of the conversion portion, a processor, and a memory storing a program which, when executed by the processor, causes the apparatus to select, from the plurality of timings, timing at which not to perform read-out of the count value.

### BACKGROUND

### Field of the Technology

The aspect of the embodiments relates to a photoelectric conversion apparatus, a control method for a photoelectric conversion apparatus, a program, and a storage medium.

### Description of the Related Art

Some photoelectric conversion apparatuses capable of detecting weak light at the single-photon level using avalanche multiplication are known. Japanese Patent Laid-Open No. 2021-153346 describes a photoelectric conversion apparatus including a waveform shaping circuit, which shapes the output waveform of each avalanche photodiode, and a counter, which generates a counting result obtained by counting signals which the waveform shaping circuit outputs. The photoelectric conversion apparatus described in Japanese Patent Laid-Open No. 2021-153346 has a configuration which reads out a counting result generated by the counter in a plurality of periods in which accumulation periods of avalanche photodiodes overlap each other within one frame.

In the technique described in Japanese Patent Laid-Open No. 2021-153346, since read-out processing of counting results generated by the counter is performed in a plurality of periods in which accumulation periods of avalanche photodiodes overlap each other and development processing that is based on the read-out counting results is performed, there is concern that electric power which is consumed by read-out processing and development processing which are performed within one frame increases.

### SUMMARY

According to an aspect of the embodiment, an apparatus includes a conversion portion configured to generate a detection signal by avalanche multiplication, a counter circuit configured to count a signal that is based on the detection signal output from the conversion portion, a read-out circuit configured to read out a count value obtained by the counter circuit, the read-out circuit being capable of reading out the count value at a plurality of timings in an accumulation period for one frame of the conversion portion, a processor, and a memory storing a program which, when executed by the processor, causes the apparatus to select, from the plurality of timings, timing at which not to perform read-out of the count value.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a photoelectric conversion element.

FIG. 2 is a diagram illustrating a configuration example of a sensor substrate.

FIG. 3 is a diagram illustrating a configuration example of a circuit substrate.

FIG. 4 is a diagram illustrating an equivalent circuit of a pixel and a signal processing circuit corresponding to the pixel included in the sensor substrate and the circuit substrate illustrated in FIGS. 2 and 3.

FIG. 5 is a diagram schematically illustrating a relationship between an operation of an avalanche photodiode (APD) and an output signal from the APD.

FIG. 6 is a block diagram of a photoelectric conversion apparatus.

FIG. 7 is a diagram used to explain a photoelectric conversion method which is performed by a camera control unit.

FIG. 8 is a diagram illustrating a relationship between memory circuits and buffers.

FIG. 9 is a flowchart illustrating the details of a driving example of the photoelectric conversion element.

FIG. 10 is a flowchart illustrating the details of a driving example of the photoelectric conversion element.

FIG. 11 is a diagram used to explain a photoelectric conversion method which the camera control unit performs when having changed a shutter speed.

FIG. 12 is a diagram used to explain a photoelectric conversion method which the camera control unit performs when having changed a shutter speed.

FIG. 13 is a diagram used to explain a photoelectric conversion method which the camera control unit performs when having performed focus control.

FIG. 14 is a diagram used to explain a photoelectric conversion method which the camera control unit performs without using a first accumulation period.

FIG. 15 is a diagram illustrating an example of a relationship between the amounts of change of shutter speed and the numbers of frames in which not to use the first accumulation period.

FIG. 16 is a diagram illustrating an example of a relationship between control targets and the numbers of frames in which not to use the first accumulation period.

FIG. 17 is a flowchart illustrating the details of a driving example of the photoelectric conversion element in a first embodiment.

FIG. 18 is a flowchart illustrating the details of a driving example of a photoelectric conversion element in a second embodiment.

### DESCRIPTION OF THE EMBODIMENTS

The following embodiments are intended to embody a technological thought of the disclosure and should not be construed to limit the disclosure. The sizes and relationships of members illustrated in the respective drawings may be exaggerated for illustrative purposes. In the following description, the same constituent elements are assigned the respective same reference characters and any repetitive description thereof may be omitted as appropriate.

### Photoelectric Conversion Element

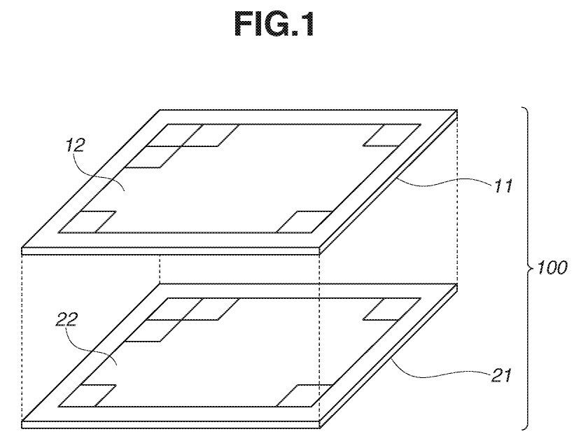

FIG. 1 is a diagram illustrating a configuration example of a photoelectric conversion element according to an embodiment of the disclosure. In the following description, a case where a photoelectric conversion element 100 is what is called a stacked photoelectric conversion device which is configured with two substrates, i.e., a sensor substrate 11 and a circuit substrate 21, being stacked on each other and being electrically connected to each other is described as an example. However, what is called a non-stacked photoelectric conversion device in which constituent elements included in a sensor substrate and constituent element included in a circuit substrate are arranged in a shared semiconductor layer can also be employed. The sensor substrate 11 includes a pixel region 12. The circuit substrate 21 includes a circuit region 22, which processes a signal detected by the pixel region 12.

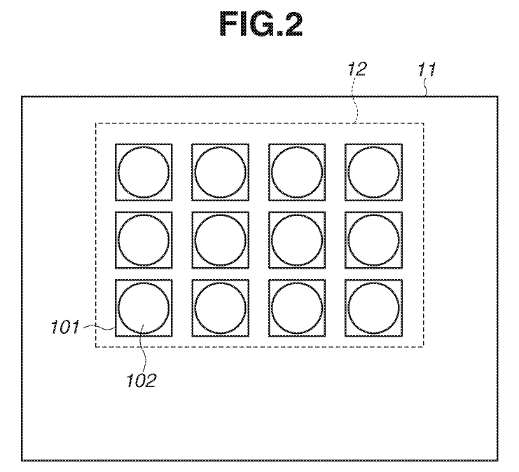

FIG. 2 is a diagram illustrating a configuration example of the sensor substrate 11. The pixel region 12 of the sensor substrate 11 includes a plurality of pixels 101 two-dimensionally arranged across a plurality of rows and a plurality of columns. Each pixel 101 includes a photoelectric conversion portion 102, which includes an avalanche photodiode (hereinafter referred to as an "APD").

Here, the photoelectric conversion portion 102 functions as a sensor portion which generates a pulse signal at a frequency corresponding to the frequency of light-receiving of photons. Furthermore, the number of rows and the number of columns of a pixel array constituting the pixel region 12 do not need to be specifically limited.

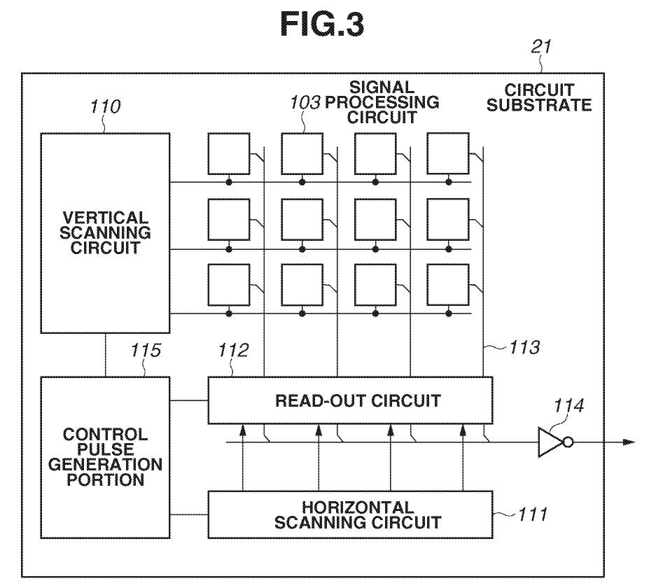

FIG. 3 is a diagram illustrating a configuration example of the circuit substrate 21. The circuit substrate 21 includes signal processing circuits 103, each of which processes electric charge obtained by photoelectric conversion performed by each photoelectric conversion portion 102 illustrated in FIG. 2, a read-out circuit 112, a control pulse generation portion 115, a horizontal scanning circuit 111, vertical signal lines 113, a vertical scanning circuit 110, and an output circuit 114.

The vertical scanning circuit 110 receives a control pulse signal supplied from the control pulse generation portion 115 and sequentially supplies a control pulse signal to each of a plurality of pixels arrayed in the row direction. The vertical scanning circuit 110 to be used is a logic circuit such as a shift register or an address decoder.

A signal output from the photoelectric conversion portion 102 of each pixel is processed by each signal processing circuit 103. The signal processing circuit 103 is provided with, for example, a counter and a memory, and a digital value is retained in the memory. To read out a signal from the memory of each pixel in which a digital signal is retained, the horizontal scanning circuit 111 inputs, to the signal processing circuit 103, a control pulse signal for sequentially selecting each column.

To the vertical signal line 113, a signal is output from the signal processing circuit 103 of a pixel in a row selected by the vertical scanning circuit 110. The signal output to the vertical signal line 113 is output, via the read-out circuit 112 and the output circuit 114, to the outside of the photoelectric conversion element 100. The read-out circuit 112 has a plurality of buffers incorporated therein, which is connected to the respective vertical signal lines 113.

As illustrated in FIGS. 2 and 3, a plurality of signal processing circuits 103 is arranged in a region which overlaps the pixel region 12 in planar view. Then, the vertical scanning circuit 110, the horizontal scanning circuit 111, the read-out circuit 112, the output circuit 114, and the control pulse generation portion 115 are arranged in such a way as to overlap each other in planar view between the end of the sensor substrate 11 and the end of the pixel region 12.

In other words, the sensor substrate 11 includes the pixel region 12 and a non-pixel region, which is arranged around the pixel region 12. Then, in a region which overlaps the non-pixel region in planar view, the vertical scanning circuit 110, the horizontal scanning circuit 111, the read-out circuit 112, the output circuit 114, and the control pulse generation portion 115 are arranged.

Furthermore, the arrangement of the vertical signal lines 113 and the arrangement of the read-out circuit 112 and the output circuit 114 are not limited to the example illustrated in FIG. 3. For example, the vertical signal lines 113 can be arranged in such a way as to extend in the row direction, and the read-out circuit 112 can be arranged at the destination to which the vertical signal lines 113 extend. Moreover, the signal processing circuits 103 do not necessarily need to be provided one by one for all of the photoelectric conversion portions 102, and a configuration in which one signal processing portion is shared by a plurality of photoelectric conversion portions so that signal processing is sequentially performed can be employed.

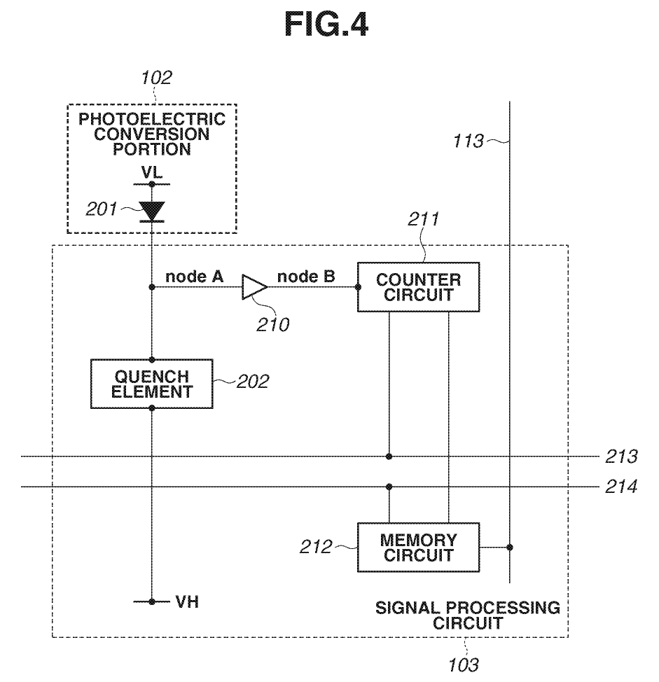

FIG. 4 is a diagram illustrating an equivalent circuit of the pixel 101 and the signal processing circuit 103 corresponding to the pixel 101 included in the sensor substrate 11 and the circuit substrate 21 illustrated in FIGS. 2 and 3.

The photoelectric conversion portion 102 generates a photon detection signal by avalanche multiplication. In the following description, the principle thereof is described. An avalanche photodiode (APD) 201 included in the photoelectric conversion portion 102 generates a charge pair corresponding to incident light by photoelectric conversion. One of the two nodes of the APD 201 is connected to a power line to which a drive voltage VL (first voltage) is supplied. Moreover, the other of the two nodes of the APD 201 is connected to a power line to which a drive voltage VH (second voltage) higher than the voltage VL is supplied.

Referring to FIG. 4, one node of the APD 201 is an anode and the other node of the APD 201 is a cathode. A reverse bias voltage is supplied to the anode and cathode of the APD 201 in such a way as to cause the APD 201 to perform an avalanche multiplication operation. In response to the APD 201 being brought into the state of being supplied with such a voltage, electric charge caused by incident light brings about avalanche multiplication, thus generating avalanche current.

Furthermore, in a case where a reverse bias voltage is supplied, there are a Geiger mode for causing the APD to operate with a voltage difference between the anode and the cathode which is greater than the breakdown voltage and a linear mode for causing the APD to operate with a voltage difference between the anode and the cathode which is close to the breakdown voltage or is less than or equal to the breakdown voltage. The APD which is caused to operate in the Geiger mode is referred to as a “single photon avalanche diode (SPAD)”. In the case of the SPAD, for example, the voltage VL (first voltage) is -30 volts (V), and the voltage VH (second voltage) is 1 V.

The signal processing circuit 103 includes a quench element 202, a waveform shaping portion 210, a counter circuit 211, and a memory circuit 212. The quench element 202 is connected to the power line to which the drive voltage VH is suppled and is connected to one of the anode and cathode of the APD 201.

The quench element 202 functions as a load circuit (quench circuit) at the time of signal multiplication caused by avalanche multiplication, and has the action of reducing the voltage to be supplied to the APD 201 and thus preventing or reducing avalanche multiplication (performing a quench operation). Moreover, the quench element 202 has the action of causing a current corresponding to a voltage drop caused by the quench operation to flow and thus returning the voltage to be supplied to the APD 201 to the drive voltage VH (performing a recharge operation).

In FIG. 4, an example in which the signal processing circuit 103 includes, in addition to the quench element 202, the waveform shaping portion 210, the counter circuit 211, and the memory circuit 212 is illustrated. However, in one embodiment, the signal processing circuit 103 only needs to include, in addition to the quench element 202, at least one of the waveform shaping portion 210, the counter circuit 211, and the memory circuit 212.

The waveform shaping portion 210 shapes a change in voltage of the cathode of the APD 201 which is obtained at the time of detection of photons, and thus outputs a pulse signal. The waveform shaping portion 210 to be used is, for example, an inverter circuit. While FIG. 4 illustrates an example in which one inverter is used as the waveform shaping portion 210, a circuit having a plurality of inverters connected in series can be used or another type of circuit having a waveform shaping effect can also be used.

The counter circuit 211 counts the number of pulses output from the waveform shaping portion 210 and then retains the obtained count value. In other words, the counter circuit 211 counts a signal that is based on a photon detection signal output from the photoelectric conversion portion 102. Thus, the signal that is based on a photon detection signal includes a pulse signal obtained by the waveform shaping portion 210 shaping a photon detection signal (voltage change) output from the photoelectric conversion portion 102.

Moreover, in response to a control pulse signal RES being supplied via a drive line 213, the signal retained in the counter circuit 211 is reset. Here, the counter circuit 211 generates a signal based on a difference between the count value obtained at the time of start of the accumulation period and the count value obtained at the time of end of the accumulation period.

The memory circuit 212 is supplied with a control pulse signal SEL from the vertical scanning circuit 110 illustrated in FIG. 3 via a drive line 214 illustrated in FIG. 4 (in FIG. 3, not illustrated) and thus switches between connection and disconnection between the counter circuit 211 and the vertical signal line 113. The memory circuit 212 functions as a memory for temporarily storing a count value obtained by the counter circuit 211 and thus outputs an output signal from the counter circuit 211 in each pixel to the vertical signal line 113.

Furthermore, a switch such as a transistor can be arranged between the quench element 202 and the APD 201 or between the photoelectric conversion portion 102 and the signal processing circuit 103 so as to switch electrical connection.

Similarly, supplying the voltage VH or the voltage VL, which is supplied to the photoelectric conversion portion 102, can be electrically switched with use of a switch such as a transistor.

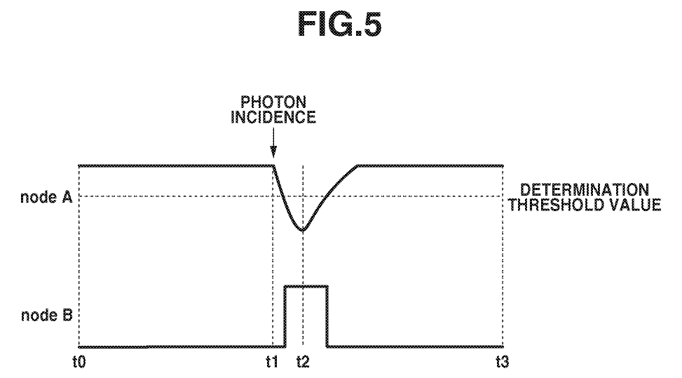

FIG. 5 is a diagram schematically illustrating a relationship between an operation of the APD 201 and an output signal from the APD 201. The node on the input side of the waveform shaping portion 210 is referred to a “node A”, and the node on the output side of the waveform shaping portion 210 is referred to a “node B”. During a period from time t0 to time t1, a potential difference “VH - VL” is applied to the APD 201. In response to photons entering the APD 201 at time t1, avalanche multiplication occurs in the APD 201 and an avalanche multiplication current flows through the quench element 202, so that the voltage of the node A drops.

When the amount of voltage drop becomes larger and the potential difference to be applied to the APD 201 becomes smaller, then, at time t2, avalanche multiplication in the APD 201 stops, so that the voltage level of the node A is caused not to drop beyond a given fixed value. After that, during a period from time t2 to time t3, a current which compensates for the amount of voltage drop flows from the node of the voltage VH to the node A, and, at time t3, the node A stabilizes at the original electric potential level. At this time, a portion of the output waveform exceeding a given threshold value in the node A is shaped in waveform by the waveform shaping portion 210 and is then output as a pulse signal in the node B.

Here, a difference between read-out processing in a general complementary metal-oxide semiconductor (CMOS) sensor and read-out processing in a photoelectric conversion element according to the embodiment is described. First, the CMOS sensor accumulates electric charge which occurs by light incident on a photodiode and reads out the accumulated electric charge, thus obtaining information concerning the intensity of the received light. Accordingly, when the CMOS sensor has once read out the electric charge accumulated in the photodiode, the electric charge is lost from the photodiode, so that it is difficult to perform read-out processing in accumulation periods overlapping in one frame period.

On the other hand, read-out processing in a photoelectric conversion element according to the embodiment, it is possible to perform read-out processing in accumulation periods overlapping in one frame period. This is because, in the case of the photoelectric conversion element according to the embodiment, a photon detection signal that is based on avalanche multiplication is counted by the counter circuit 211 and a count value obtained by the counter circuit 211 is then temporarily stored in the memory circuit 212. Read-out processing which is performed by the read-out circuit 112 is processing for reading out, via the memory circuit 212, a count value obtained by the counter circuit 211. The count value obtained by the counter circuit 211 is a digital signal and is retained unless the control pulse signal RES is supplied, and, therefore, the count value is not lost by read-out processing which is performed from the photoelectric conversion element 100. Moreover, since there is no read-out noise, even if read-out processing is performed many times in one-time accumulation, an original signal does not deteriorate. Accordingly, the photoelectric conversion element according to the embodiment is capable of reading out count values in a plurality of overlapping accumulation periods included in an accumulation period for one frame. In other words, the read-out circuit 112 is capable of reading out count values at a plurality of timings in an accumulation period for one frame. In this way, reading out information concerning brightness (count values) without loss thereof is referred to as "non-destructive read-out", and processing for non-destructive read-out is referred to as "non-destructive read-out processing".

Here, an accumulation period for one frame in the embodiment is a period from when the counter circuit 211 starts counting until the count value is reset. Since the count value obtained by the counter circuit 211 is reset in response to the control pulse signal RES being supplied to the counter circuit 211 via the drive line, the accumulation period for one frame is determined by input timing of the control pulse signal RES serving as a reset signal. Since the counter circuit 211 outputs, at timing when the reset signal is input, a count value obtained at that time, the count value which has been output becomes an image signal for one frame. Then, the count value which has been output is subjected to development processing and image processing, so that an image for one frame is generated. A frame is a unit which represents a still image, and, while a single frame is a still image, a moving image is formed by a plurality of frames being generated in a temporally serial manner and being sequentially reproduced. Accordingly, the accumulation period for one frame refers to a time frame for accumulating an image signal in a process for generating a single still image, and the time frame is defined in various forms. Defining the time frame by timing of the reset signal which is input to the counter circuit 211 is an example of one of the various forms. Additionally, the time frame can also be defined by controlling a quench operation to be performed on the APD 201 and thus controlling a period in which the photoelectric conversion element is operating in such a way as to be able to detect photons. Alternatively, the accumulation period can also be defined by controlling a period in which light passes through in front of a sensor such as a mechanical shutter and physically enters the sensor. Accordingly, conceptually, the accumulation period for one frame is a period in which to acquire an image signal for generating one frame (still image). Thus, the accumulation period for one frame is, for example, a period in which light is entering the light receiving surface of the photoelectric conversion element 100, a period in which the photoelectric conversion element 100 is operating in such a way as to be able to detect photons, or a period from the start of counting by the counter circuit 211 to the end of counting by the counter circuit 211. Furthermore, the accumulation period can also be read as an exposure period. In the embodiment, as mentioned above, the period from when the counter circuit 211 starts counting until the count value is reset is referred to as an "accumulation period for one frame".

### First Embodiment

### Apparatus Configuration

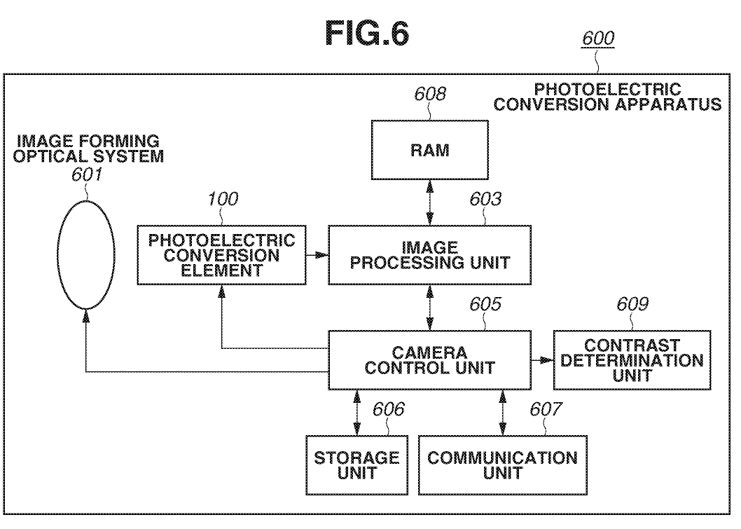

FIG. 6 illustrates a configuration example of a photoelectric conversion apparatus according to a first embodiment. Some functional blocks illustrated in FIG. 6 can be implemented by causing a computer (not illustrated) included in the photoelectric conversion apparatus 600 to execute a computer program stored in a memory serving as a storage medium (not illustrated). Furthermore, some or all of the functional blocks can be configured to be implemented by hardware. The hardware to be used is, for example, a dedicated circuit such as an application specific integrated circuit (ASIC) or a processor such as a reconfigurable processor or digital signal processor (DSP). Moreover, the functional blocks illustrated in FIG. 6 do not need to be incorporated in the same chassis and can be configured as separate devices interconnected via signal paths.

The photoelectric conversion apparatus 600 includes the photoelectric conversion element 100 described above with reference to FIGS. 1 to 5, an image forming optical system 601, an image processing unit 603, a camera control unit 605, a storage unit 606, a communication unit 607, and a random access memory (RAM) 608. The photoelectric conversion element 100 is configured with avalanche photodiodes (APDs) described above with reference to FIGS. 1 to 5, which are used for photoelectrically converting an optical image.

The image processing unit 603 performs predetermined processing operations, such as black level correction, gamma curve adjustment, noise reduction, and data compression, on signals acquired by the photoelectric conversion element 100 with data temporarily stored in the RAM 608, and thus generates a final image signal. Furthermore, in a case where the photoelectric conversion element 100 includes an on-chip color filter such as a red-green-blue (RGB) color filter, in one embodiment, processing operations such as white balance correction and color conversion are performed in the image processing unit 603.

The camera control unit 605 has, incorporated therein, a central processing unit (CPU) serving as a computer and a memory storing a computer program, and performs control of each unit of the photoelectric conversion apparatus 600 by the CPU executing the computer program stored in the memory.

Furthermore, the camera control unit 605 functions as a control unit, and performs, for example, control of the length of an accumulation period for each frame in the photoelectric conversion element 100 and the timing of a control signal CLK via, for example, the control pulse generation portion 115 of the photoelectric conversion element 100. Moreover, the photoelectric conversion apparatus 600 also includes a contrast determination unit 609, and the camera control unit 605 outputs a control signal to a drive unit of the image forming optical system 601 according to a determination result provided by the contrast determination unit 609, and thus also performs, for example, focus control.

The storage unit 606 includes, for example, a recording medium such as a memory card or hard disk drive, and is capable of storing and reading out an image signal. The communication unit 607 include a wireless or wired interface, and outputs a generated image signal to the outside of the photoelectric conversion apparatus 600 and also receives various signals from the outside thereof.

### Photoelectric Conversion Method

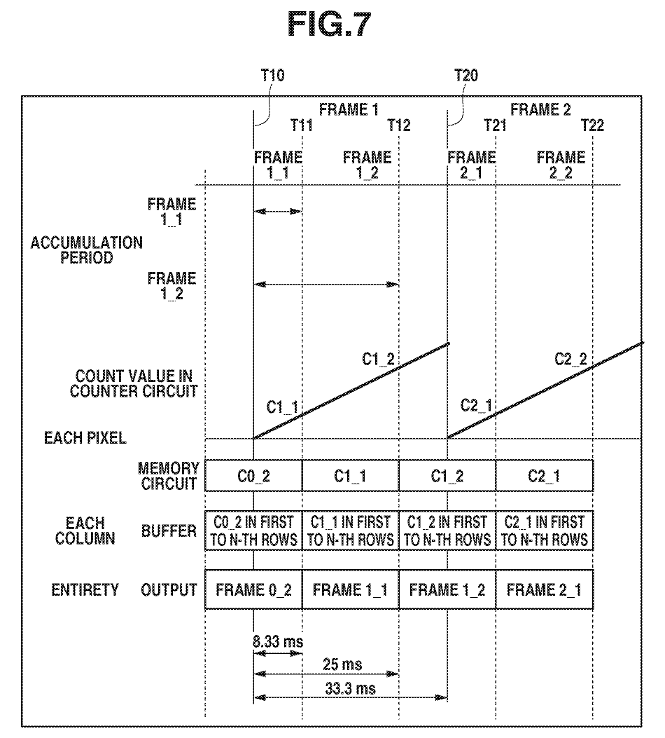

FIG. 7 is a diagram used to explain a photoelectric conversion method which the camera control unit 605 performs according to the first embodiment. In the first embodiment, the length of an accumulation period for one frame is assumed to be 33.3 milliseconds (ms), to which each of a frame 1 and a frame 2 corresponds. With respect to the frame 1, at time T10 and with respect to the frame 2, at time T20, the counter circuit 211 resets the count value and starts counting.

In an accumulation period for the frame 1, read-out processing is performed by the read-out circuit 112 at two times of timing, i.e., time T11 and time T12, and, similarly, in an accumulation period for the frame 2, read-out processing is performed by the read-out circuit 112 at two times of timing, i.e., time T21 and time T22.

Therefore, a frame 1_1 has an accumulation period from the start time T10 of the frame 1 until time T11 (8.33 ms, i.e., an accumulation period for 1/4 of the frame 1), and a frame 1_2 has an accumulation period from time T10 until time T12 (25 ms, i.e., an accumulation period for three times the frame 1_1). Thus, the accumulation period for the frame 1_1 and the accumulation period for the frame 1_2 overlap, and the accumulation period for the frame 1_2 is longer than the accumulation period for the frame 1_1 (this being also true for the frame 2).

A count value C1_1 by the counter circuit 211 in an accumulation period from time T10 to time T11 is a count value which has been read out at timing of time T11. Similarly, count values C1_2, C2_1, and C2_2 are count values which have been read out at timing of time T12, time T21, and time T22, respectively. Furthermore, a configuration in which, with respect to the count value in the accumulation period for the frame 1_1, count values are read out from not all of the pixels at timings of time T11 but count values are read out for every row or for every plurality of rows over time T11 to time T12 can be employed. Moreover, in one embodiment, in a period from time T11 to time T12, the count value C1_1 is subjected to development processing by the image processing unit 603. Similarly, the signals accumulated in the period of the frame 1_2 are sequentially read out and subjected to development processing over time T12 to time T21.

In this way, in the first embodiment, control is performed in such a manner that a first accumulation period and a second accumulation period are included in one frame, the first accumulation period is shorter than the second accumulation period, and signals generated in the first accumulation period are output during a period from the end of the first accumulation period to the end of the second accumulation period.

Moreover, in the first embodiment, the first accumulation period and the second accumulation period overlap and the first accumulation period and the second accumulation period start at the same time. Additionally, the time of end of the second accumulation period serves as a frame separation and the second accumulation period is the integral multiple of the first accumulation period. The first accumulation period corresponds to, for example, the frame 1_1 or the frame 2_1 and represents read-out timing provided in each frame. Similarly, the second accumulation period corresponds to, for example, the frame 1_2 or the frame 2_2 and represents read-out timing longer (slower) than the first accumulation period and provided in each frame.

Thus, an image shorter in accumulation period and an image longer in accumulation period are generated, and the timing at which the shorter accumulation period ends is set earlier than the timing at which the longer accumulation period ends, and, as soon as the shorter accumulation period ends, the image shorter in accumulation period is output and is then sent to the image processing unit 603.

In the first embodiment, since the photoelectric conversion element 100 is capable of performing non-destructive read-out, it is possible to perform read-out processing in a 1/4 frame period (first accumulation period) during an accumulation period for one frame. Then, it is possible to perform image processing on the read-out image signal (count value) for the first accumulation period.

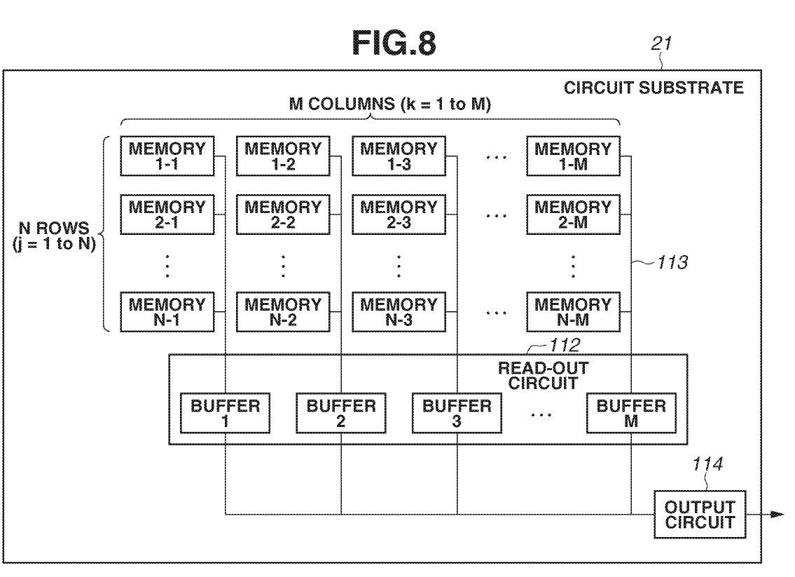

FIG. 8 is a diagram illustrating a relationship between the memory circuits and buffers in the first embodiment. FIG. 8 illustrates a state in which the memory circuits 212 included in the signal processing circuit 103 illustrated in FIG. 3 are arrayed in N rows and M columns, and the respective memory circuits are denoted as a memory 1-1 to a memory N-M. Moreover, a buffer 1 to a buffer M illustrated in FIG. 8 represent buffers included in the read-out circuit 112 illustrated in FIG. 3. An output circuit 114 illustrated in FIG. 8 corresponds to the output circuit 114 illustrated in FIG. 3.

### Description of Operation

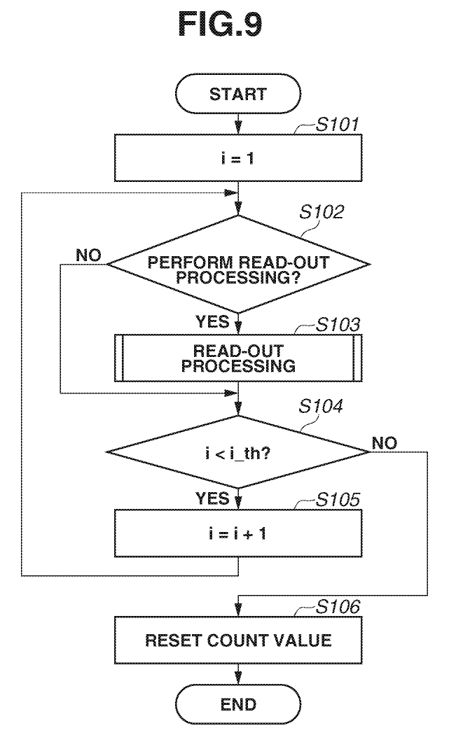

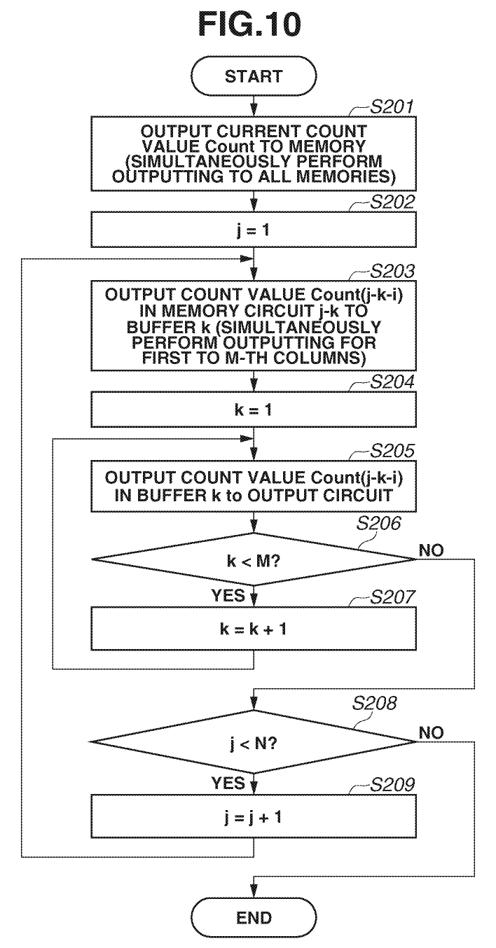

FIGS. 9 and 10 are flowcharts illustrating operation examples of the photoelectric conversion apparatus according to the first embodiment. Furthermore, operations of the respective steps in the flowcharts of FIGS. 9 and 10 are sequentially performed by, for example, a CPU serving as a computer included in the camera control unit 605 executing a computer program stored in the storage unit 606.

In step S101 illustrated in FIG. 9, the CPU performs setting of "i = 1". The variable "i" corresponds to the number of times of read-out from the time when the photoelectric conversion element starts image capturing for one frame. In other words, the variable "i" indicates starting of the i-th read-out in the photoelectric conversion element. Accordingly, the setting of "i = 1" means starting the first read-out operation of the photoelectric conversion element. For example, the timing of time T11 illustrated in FIG. 7 corresponds to the timing at which the CPU performs setting of "i = 1" to perform read-out processing. Similarly, the variable "i" corresponds to each time which has been set in the photoelectric conversion element.

In step S102, the CPU determines whether the value of the current variable "i" is timing at which to perform read-out processing. The photoelectric conversion apparatus according to the first embodiment is characterized by selecting, from a plurality of timings of the respective times T11 to T22 in control of the photoelectric conversion element, timing at which not to perform read-out processing. Specifically, the CPU preliminarily designates the value of the variable "i" for not performing read-out processing. The value of the variable "i" for not performing read-out processing is preliminarily stored in the storage unit 606 or is selectable by a method described below. If the result of determination in step S102 is Yes (YES in step S102), then in step S103, the CPU performs read-out processing. On the other hand, if the result of determination in step S102 is No (NO in step S102), the CPU skips step S103 and advances the processing to step S104.

In step S103, the CPU performs read-out processing. In the case of "i = 1", the CPU performs the first red-out processing during an accumulation period for one frame. In the case of the example illustrated in FIG. 7, the CPU performs read-out processing for the frame 1_1 during an accumulation period for the frame 1. Upon completion of the read-out processing in step S103, the CPU advances the processing to step S104. This read-out processing is, as mentioned above, non-destructive read-out processing, so that no count value is lost by the processing operation in step S103.

In step S104, the CPU determines whether the variable "i" is less than a threshold value i_th. The threshold value i_th is previously set to a desired number of times of read-out in a period for one frame. If "i_th = 2" is set, read-out processing is performed two times in one frame period. While this number of time of read-out can be set to a desired value, in one embodiment, a feasible number of times is set in consideration of various constraints such as physical limits of the photoelectric conversion element, the capacities of subsequent-stage buffers for taking in read-out signals, or times required for image processing. If the result of determination in step S104 is Yes, i.e., the value of the variable "i" is less than the set number of times of read-out (YES in step S104), the CPU advances the processing to step S105. If the result of determination in step S104 is No, i.e., the value of the variable "i" has reached the set number of times of read-out (NO in step S104), the CPU advances the processing to step S106.

In step S105, the CPU increments the variable "i", and then returns the processing to step S102. For example, in a case where the variable "i" is equal to "1", the operation in step S105 causes the variable "i" to become equal to "2", so that an operation for the second read-out processing in an accumulation period for one frame is started.

In step S106, the CPU resets the counter circuit 211 with the reset signal. The result of determination in step S104 being No means that all of the processing operations in the read-out timings set in an accumulation period for one frame have been completed. Accordingly, the CPU determines that the accumulation period for one frame has expired and thus brings the count value into "0". This operation corresponds to a reset operation of the counter circuit 211 which is performed at time T10 and time T20 illustrated in FIG. 7. Furthermore, at such timing, the value of the variable "i" is also reset to "0".

As described above, the photoelectric conversion apparatus according to the first embodiment is capable of performing, at a plurality of timings, non-destructive read-out processing on signals accumulated in the photoelectric conversion element 100. Then, the photoelectric conversion apparatus is capable of selecting, from among the plurality of timings, timing at which not to perform reading-out of a count value.

In the case of a conventional CMOS sensor, since it is difficult to perform non-destructive read-out processing, read-out processing and image processing are performed once per one frame. Therefore, a photoelectric conversion method which differs from a method used for the CMOS sensor and which uses avalanche multiplication to generate a photon detection signal and counts a signal that is based on the photon detection signal has been employed to implement a photoelectric conversion element capable of performing non-destructive read-out. In a conventional technique, such a photoelectric conversion element capable of performing non-destructive read-out is used to enable setting a plurality of timings for non-destructive read-out and obtaining images in a plurality of accumulation periods which overlap each other.

However, since non-destructive read-out processing and image processing are performed at all of the plurality of timings of non-destructive read-out which have been set, there is concern that power consumption increases as compared with the case of performing read-out once per one frame as in the CMOS sensor.

Since the photoelectric conversion apparatus according to the first embodiment selects timing at which not to perform read-out processing in a previously set plurality of read-out timings, it is possible to reduce power consumption caused by read-out processing and subsequent-stage image processing.

### Read-out Processing

FIG. 10 is a flowchart illustrating read-out processing in step S103 illustrated in FIG. 9.

In step S201, the CPU outputs a count value Count obtained by the counter circuit 211 at the current time to the memory circuit 212. At this time, the CPU simultaneously performs outputting to all of the memory circuits 212. This operation corresponds to the operation which is performed at time T11 illustrated in FIG. 7.

Next, in step S202, the CPU performs setting of "j = 1", and then in step S203, the CPU outputs a count value Count(j-k-i) in a memory circuit j-k illustrated in FIG. 8 to a buffer k. At this time, the CPU simultaneously performs outputting for the first to M-th columns to buffers. This operation means an operation which takes, into buffers, count values in the first row illustrated in FIG. 8.

Next, in step S204, the CPU performs setting of "k = 1", and then in step S205, the CPU outputs a count value Count(j-k-i) in the buffer k to the output circuit 114. This operation corresponds to an operation which reads out, from the output circuit 114, a signal in the buffer in the leftmost column illustrated in FIG. 8.

Next, in step S206, the CPU determines whether k < M, and, if the result of determination is Yes (YES in step S206), then in step S207, the CPU increments the variable "k" to perform setting of "k = k + 1" and then returns the processing to step S205, thus performing the processing operation in step S205. This operation corresponds to an operation which reads out, from the output circuit 114, a signal in the buffer in the second column from the left illustrated in FIG. 8.

If the result of determination in step S206 is No (NO in step S206), i.e., the variable "k" has become equal to "M" (k = M), this means that the CPU has completed reading out, from the output circuit 114, a signal in the buffer in the M-th column from the left illustrated in FIG. 8, and then in step S208, the CPU determines whether j < N. If the result of determination in step S208 is Yes (YES in step S208), then in step S209, the CPU increments the variable "j" to perform setting of "j = j + 1" and then returns the processing to step S203. This operation corresponds to an operation which starts performing reading-out for the next row.

If the result of determination in step S208 is No (NO in step S208), since this means that read-out for all of the rows to the N-th row has been completed, the CPU ends the read-out processing.

While, in the first embodiment, an accumulation is performed for a 1/4 frame period at the shortest, the length of the shortest accumulation period can be changed to, for example, a 1/5 frame period or a 1/3 frame period according to the moving speed of a subject. Alternatively, the length of the shortest accumulation period can be changed according to the brightness of a subject. Moreover, while in the above-described first embodiment, read-out is performed two times within one frame, the number of times of read-out within one frame can be changed according to the length of the accumulation period.

Additionally, even in a case where the read-out period is set to a 1/4 frame period, the counter circuit 211 can be reset in the middle of an accumulation period for the frame 1_1 illustrated in FIG. 7 according to, for example, the brightness of a subject or an image recognition accuracy. This can be used to make a substantial accumulation period shorter than the 1/4 frame period.

Alternatively, the counter circuit 211 can be once reset, for example, at time T11 illustrated in FIG. 7. This can be used to adjust a count value which is read out at time T12.

The above-described configuration enables the camera control unit 605 to change an acquisition condition for an image signal in a second accumulation period based on a signal which is generated in a first accumulation period. For example, the image processing unit 603 performs determination by comparing the brightness of a signal which is generated in the first accumulation period with a preliminarily set predetermined value. Based on the result of determination performed by the image processing unit 603, the camera control unit 605 is able to change control on the photoelectric conversion element 100 in such a manner that the signal which is generated in the second accumulation period has a desired brightness.

### Utilization of Image Signal Obtained by Non-destructive Read-out

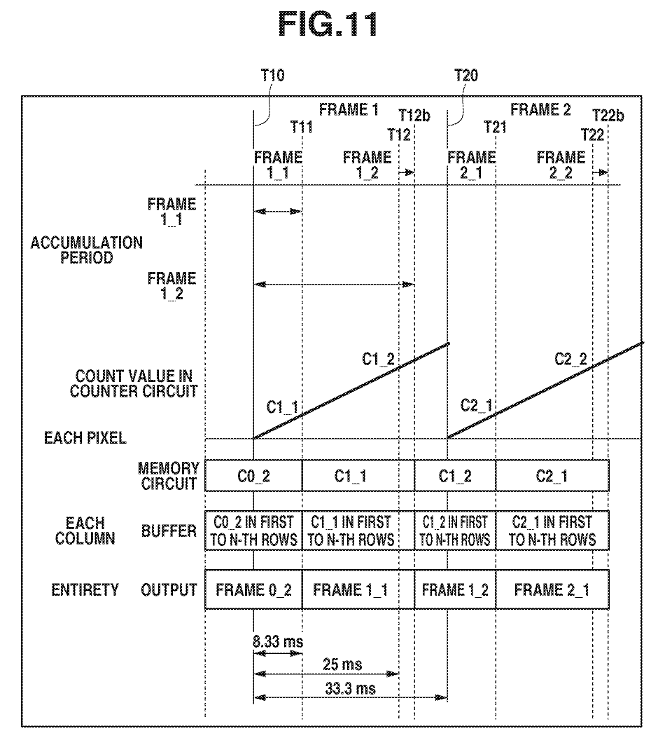

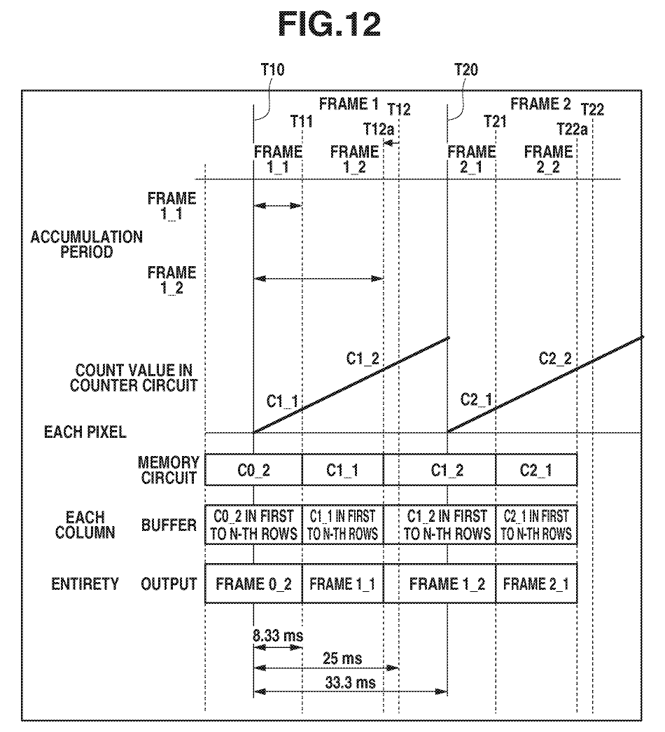

The utilization of an image signal obtained by non-destructive read-out in the first embodiment is described. As an example thereof, an operation which is performed in the case of changing the brightness is described. FIGS. 11 and 12 are diagrams each used to explain a photoelectric conversion method which is performed by the camera control unit 605 according to the first embodiment, as with FIG. 7. Unlike FIG. 7, in the case of FIG. 11, if it is determined that a signal which is generated in the accumulation period for the frame 1_1 is darker than the predetermined brightness, the exposure condition is changed and control is performed in such a manner that a signal which is generated in the accumulation period for the frame 1_2 has the desired brightness. Changing of an exposure is performed by changing the shutter speed, and the determination of brightness is performed in consideration of an accumulation period for the frame 1_1. Since, here, the accumulation period for the frame 1_1 is set to 1/3 of the accumulation period for the frame 1_2, the determination is performed based on a brightness obtained by multiplying the brightness in the frame 1_1 by 3.

As illustrated in FIG. 11, in a case where it is determined that the signal which is generated in the accumulation period for the frame 1_1 is darker than the predetermined brightness, changing for making the shutter speed longer within one frame is performed by changing the end of the accumulation period for the frame 1_2 from time T12 to time T12b. Furthermore, in a case where it is determined that, conversely, the signal which is generated in the accumulation period for the frame 1_1 is brighter than the predetermined brightness, changing for making the shutter speed shorter within one frame is performed by changing the end of the accumulation period for the frame 1_2 from time T12 to time T12a as illustrated in FIG. 12. In this way, by changing the exposure condition with the shutter speed, it is possible to change the brightness of a signal which is generated in the accumulation period for the frame 1_2.

Moreover, it is also possible to change focus control in the second accumulation period with use of a contrast determination result obtained by the contrast determination unit 609 about a signal which is generated in the first accumulation period.

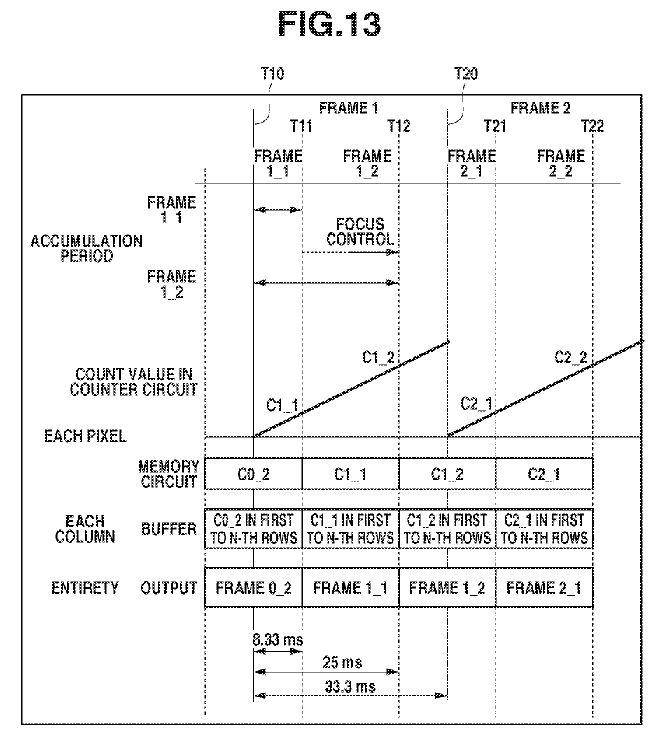

As illustrated in FIG. 13, the contrast determination unit 609 performs contrast determination with an image which is generated in the accumulation period for the frame 1_1. During the period from time T11 to time T12 in the accumulation period for the frame 1_2, the camera control unit 605 controls the drive unit of the image forming optical system 601 based on a result of the contrast determination, thus adjusting the focus of the image forming optical system 601.

Performing such focus control enables performing feedback to a signal which is generated in the accumulation period for the frame 1_2.

An image longer in accumulation period enables increasing contrast or signal-to-noise ratio (SNR), and an image shorter in accumulation period is adapted for a case where the user wants to promptly perform, for example, recognition processing. Accordingly, it is possible to, while setting an image obtained in the second accumulation period, which is an accumulation period longer than the first accumulation period, as an image to be displayed to the user, utilize an image obtained by non-destructive read-out in the first accumulation period as an image used for image recognition processing. With regard to, for example, image recognition processing using artificial intelligence (AI), there is a waiting time until a result of the image recognition processing is output. Therefore, performing recognition processing in the first accumulation period enables promptly obtaining a recognition result without waiting for an image obtained in the second accumulation period. On the other hand, using an image obtained in the second accumulation period as an image to be displayed to the user enables, while promptly obtaining a result of recognition processing, displaying an image better in contrast or SNR than an image obtained in the first accumulation period as an image to be displayed.

Furthermore, an image obtained in the first accumulation period can be displayed, or a wide dynamic range image obtained by combining an image obtained in the first accumulation period and an image obtained in the second accumulation period with each other can be generated and displayed.

Moreover, with regard to subject recognition, similarly, recognition processing can also be performed based on a signal which is generated in the first accumulation period and, additionally, based on a recognition processing result obtained in the first accumulation period, recognition processing using a signal which is generated in the second accumulation period can be performed. In this way, preliminarily performing recognition processing using a signal obtained in the first accumulation period enables promptly performing subject recognition.

### Method of Selecting Timing at which Not to Perform Read-out Processing

In the description so far, an advantageous effect of reducing power consumption caused by read-out processing and subsequent-stage image processing by selecting timing at which not to perform read-out processing from among a plurality of read-out timings has been described. While the advantageous effect of reducing power consumption can also be obtained even by (the user or designer) preliminarily determining and selecting timing at which not to perform read-out processing, here, a more favorable selection method is described.

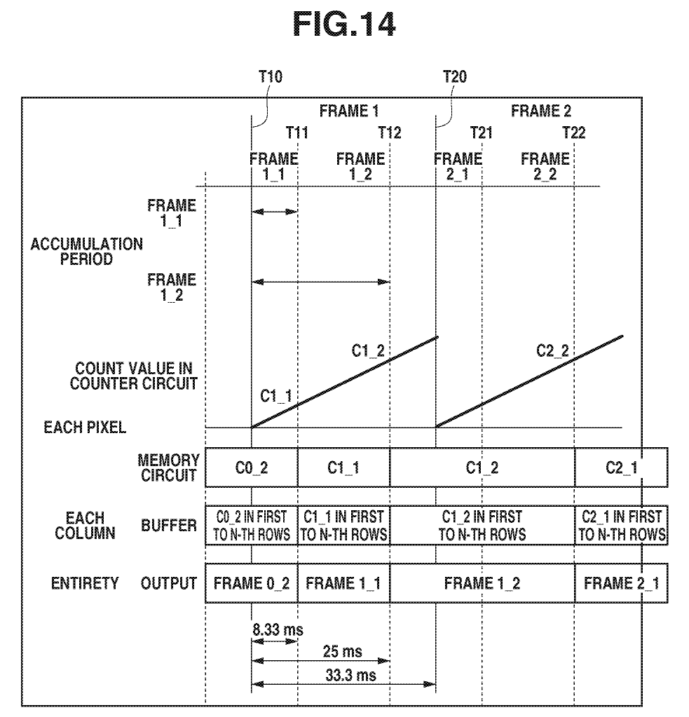

FIG. 14 is a diagram used to explain a photoelectric conversion method which is performed by the camera control unit 605, as with FIG. 7. The method illustrated in FIG. 14 differs from the method illustrated in FIG. 7 in that, in the frame 2, read-out processing is not performed at a timing corresponding to the frame 2_1. The method of selecting the frame 2_1 is described.

### Selection Based on Control Information

In the period for the frame 1, as mentioned above, a signal accumulated in the period for the frame 1_1 is read out and, next, a signal accumulated in the period for the frame 1_2 is read out. Furthermore, based on an image signal acquired in the frame 1_1, the camera control unit 605 (control unit) calculates control information to be applied in the frame 1_2. Here, the control information is control information for the photoelectric conversion element or the photoelectric conversion apparatus. More specifically, examples of the control information include an exposure condition as explained above with regard to the (above-mentioned) utilization of an image signal obtained by non-destructive read-out. Besides, the control information can include, for example, a result of determination of contrast of an image signal performed by the contrast determination unit 609 or control parameters for the image forming optical system 601 that are based on the result of determination. Thus, in one embodiment, the control information only needs to be acquired based on an image signal read out by non-destructive read-out.

Here, the CPU makes a comparison between control information calculated in the frame 1_1 and control information calculated in the previous frame (a frame occurring one frame before the frame 1_1). In a case where, as a result of the comparison, a difference between the pieces of control information is less than or equal to a preliminarily defined predetermined amount (more favorably, the state in which the difference is less than or equal to the predetermined amount is continuing over a predetermined number of frames), then in the next frame 2, the CPU preliminarily selects timing of time T21 as timing at which not to perform read-out processing. Thus, the CPU preliminarily stores "i = 2" as timing at which not to perform read-out processing.

For example, in a case where the control information is a shutter speed, the CPU compares a shutter speed calculated in the frame 1_1 and a shutter speed in a frame equivalent to an accumulation period for the frame 1_1 in an accumulation period occurring before the frame 1 with each other. At this time, in a case where the amount of change of the shutter speed is less than or equal to a 1/3 step, the CPU can determine that there is no large change in brightness between two frames. Accordingly, the CPU selects timing equivalent to an accumulation period for the frame 2_1 (corresponding to an accumulation period for the frame 1_1) in an accumulation period for the frame 2 as timing at which not to perform read-out processing. Instead of making a comparison between two frames, the CPU can determine whether the amount of change of the shutter speed is less than or equal to a predetermined amount between a plurality of frames. This also enables preventing or reducing such an erroneous operation that read-out processing is unfavorably omitted due to the shutter speed instantaneously changing.

Moreover, while read-out is not performed in the frame 2_1 as a next frame, read-out can be configured not to be performed not only in the next frame but over an optional plurality of frames. Alternatively, the number of frames in which not to perform read-out can be determined based on the amount of change of control information between at least two frames.

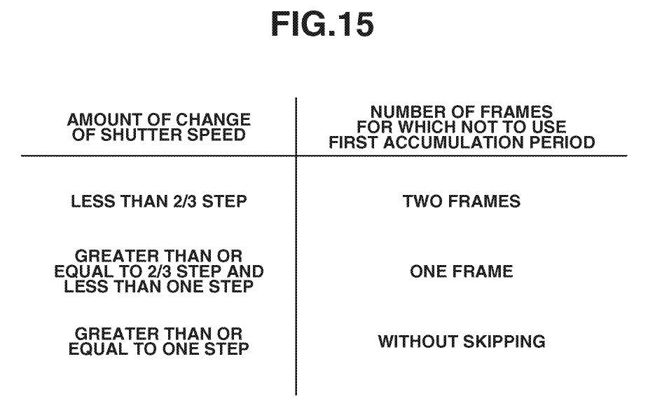

For example, similarly, in the case of an example in which the control information is a shutter speed, such determination can be described with reference to FIG. 15. FIG. 15 illustrates a table showing the number of frames in which not to perform read-out processing according to the amount of change of the shutter speed. In the case of the example illustrated in FIG. 15, selection is performed in such a manner that, as the amount of change of the control information is smaller, the number of frames in which not to perform read-out processing is set larger. For example, in a case where the shutter speed changes by greater than or equal to one step from the shutter speed calculated in the previous frame, the CPU reads out a signal in the first accumulation period even with respect to the next frame. Thus, the CPU does not select timing at which not to perform read-out processing.

On the other hand, in a case where the amount of change of the shutter speed from the shutter speed calculated in the previous frame is greater than or equal to a 2/3 step and less than one step, with respect to one frame as the next frame, read-out of a signal in the first accumulation period is set not to be performed. Additionally, in a case where the amount of change of the shutter speed from the shutter speed calculated in the previous frame is less than a 2/3 step, with respect to two frames as the next frame and the further next frame, read-out of a signal in the first accumulation period is set not to be performed.

In this way, it is possible to set the number of frames in which not to perform read-out of a signal in the first accumulation period according to the amount of change of control information.

While, here, the number of frames in which not to perform read-out of a signal in the first accumulation period is set as one frame and two frames, the number of frames can be set as a larger number of frames.

Moreover, the number of frames in which not to use the first accumulation period can be changed according to control targets.

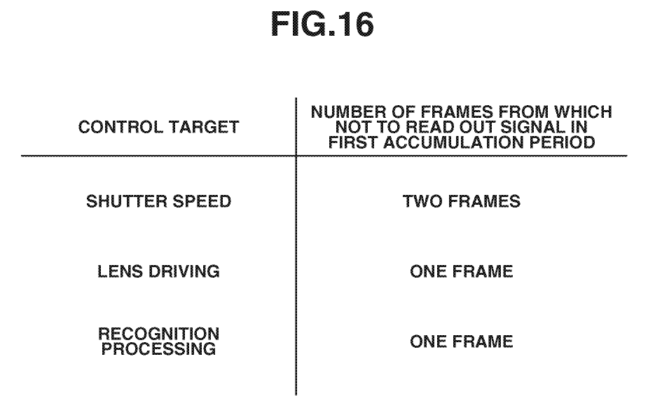

FIG. 16 illustrates a table showing the numbers of frames in which not to read out a signal in the first accumulation period for the respective control targets.

In the case of controlling the shutter speed to correct brightness, assuming that the photoelectric conversion apparatus 600 is in an environment in which the brightness does not change abruptly, the number of frames in which not to read out a signal in the first accumulation period is set as two frames. On the other hand, in the case of focus control or subject recognition, which depends on the movement of a subject, in consideration of tracking ability, the number of frames in which not to read out a signal in the first accumulation period is set as one frame. Here, as an example, the numbers of frames in which not to read out a signal in the first accumulation period are set as mentioned above, but can be configured to be optionally changeable according to image capturing conditions. Moreover, the numbers of frames in which not to read out a signal in the first accumulation period can be configured to be further changeable according to the above-mentioned amounts of change.

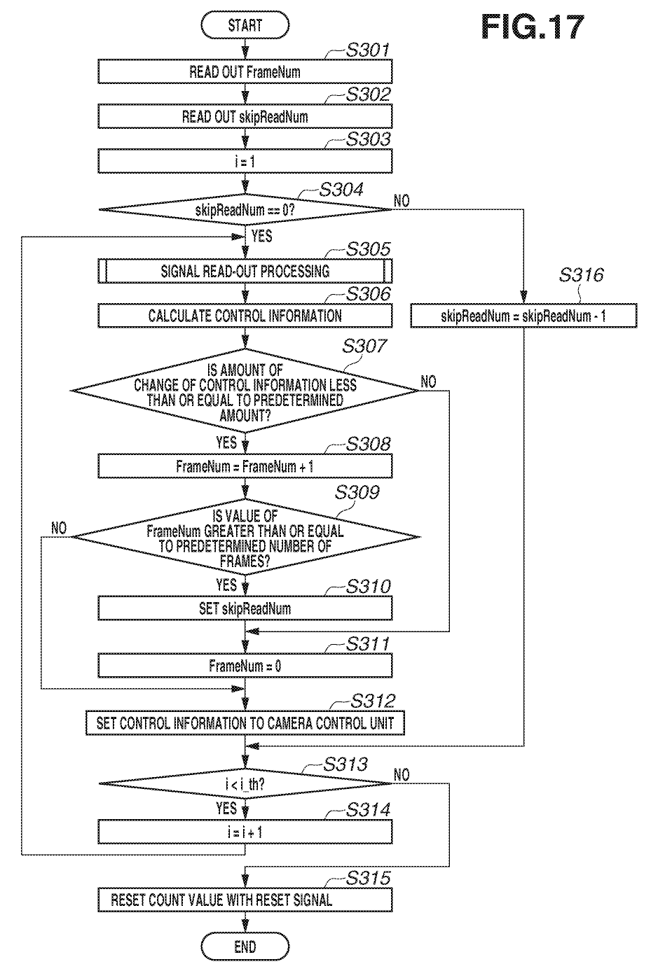

Next, an operation which selects a frame in which not to read out a signal in the first accumulation period, based on control information calculated from an image in the first accumulation period is described in detail with reference to the flowchart of FIG. 17.

First, in step S301, the CPU reads out a variable FrameNum which has information about the number of frames in which the amount of change between control information calculated from a signal in the first accumulation period and the previously calculated control information has continued to be less than or equal to a predetermined amount. In step S302, the CPU reads out a variable skipReadNum which indicates the number of frames in which not to read out a signal in the first accumulation period. Here, it is assumed that, after being reset to "0" by initialization at the time of power-on, the variable FrameNum and the variable skipReadNum have, stored therein, respective updated values by various processing operations.

Next, in step S303, the CPU performs setting of "i = 1". In step S304, the CPU determines whether the variable skipReadNum is equal to "0" (skipReadNum == 0), and, if it is determined that the variable skipReadNum is equal to "0" (YES in step S304), then in step S305, the CPU performs read-out processing. The read-out processing corresponds to the above-described processing in the flowchart of FIG. 10.

Upon completion of the read-out processing, then in step S306, the CPU calculates control information to be used by the camera control unit 605 from the read-out signal, and then stores the calculated control information. In step S307, the CPU compares the previously calculated control information and the control information calculated in step S306 with each other and determines whether the amount of change therebetween is less than or equal to a predetermined amount. In other words, the CPU determines whether a change in the control information is outside a predetermined range or within the predetermined range. If, in step S307, it is determined that the amount of change in the control information is less than or equal to the predetermined amount (YES in step S307), then in step S308, the CPU increments the variable FrameNum.

Next, in step S309, the CPU determines whether the value of the variable FrameNum is greater than or equal to a predetermined number of frames. If it is determined that the value of the variable FrameNum is greater than or equal to the predetermined number of frames (YES in step S309), then in step S310, the CPU sets the variable skipReadNum. Next, in step S311, the CPU initializes the value of the variable FrameNum to "0". After that, in step S312, the CPU sets the control information set in step S306 to the camera control unit 605.

If, in step S307, it is determined that the amount of change in the control information is neither less than nor equal to the predetermined amount (NO in step S307), then in step S311, the CPU performs setting of "FrameNum = 0". If, in step S309, it is determined that the value of the variable FrameNum is neither greater than nor equal to the predetermined number of frames (NO in step S309), then in step S312, the CPU sets the control information to the camera control unit 605.

In step S313, the CPU determines whether "i < i_th". The threshold value i_th is similar to that described with reference to FIG. 9 and is, therefore, omitted from description here. In the description here, it is assumed that the threshold value i_th is equal to "2" (i_th = 2) as with the description of FIG. 9.

If the result of determination in step S313 is Yes (YES in step S313), then in step S314, the CPU increments the variable "i" to perform setting of "i = i + 1", and then returns the processing to step S305. This operation corresponds to an operation which starts performing reading-out at next time T12 or T22.

If, in step S304, it is determined that the variable skipReadNum is not "0" (NO in step S304), then in step S316, the CPU decrements the variable skipReadNum, and then advances the processing to step S313.

If the result of determination in step S313 is No (NO in step S313), this means that read-out at time T12 or T22 has been completed, then in step S315, the CPU resets the counter circuit 211 with the reset signal. This operation corresponds to a reset operation which is performed by the counter circuit 211 at time T12 or T22 illustrated in FIG. 7. In the above-described way, it is possible to sequentially read out signals accumulated in the photoelectric conversion element 100.

As described above, in a case where a change in the control information is within a predetermined range, the CPU selects timing at which not to perform read-out of a count value, in such a way as to decrease the number of times of read-out of a count value (in such a way as to increase the variable skipReadNum). Furthermore, while, in the first embodiment, in a case where a change in the control information is outside the predetermined range, the number of times of read-out of a count value is maintained, the CPU can be configured to increase the number of times of read-out of a count value (decrease the variable skipReadNum).

While, in the first embodiment, the number of times of read-out in one frame (corresponding to the threshold value i_th) is set as two times, the number of times of read-out can be made larger. In that case, the determination of the amount of change can be performed based on a comparison with control information calculated from a signal read out at the same timing as that in a previous frame (a frame one frame before the current frame) or a comparison with control information obtained by averaging pieces of control information calculated from a plurality of signals read out from the previous frame. Methods other than these methods can be used for comparison. Moreover, in a case where it is determined not to perform read-out of a signal which is in the process of being accumulated, control which decreases the number of times of read-out in one frame can be employed.

### Other Selection Methods

As a method of selecting timing at which not to perform read-out of a count value, a method which uses a count value is described. In this case, a count value to be referred to is a count value obtained by the memory circuit 212 included in the photoelectric conversion element 100.

For sake of simplicity, the method of selecting timing at which not to perform read-out of a count value based on a count value is described with reference to the flowchart of FIG. 9. This selection method differs from that illustrated in FIG. 9 only in the determination processing in step S102.

First, in step S102, in the case of "i = 1", the CPU definitely performs read-out processing. Accordingly, in the case of "i = 1", the determination processing itself in step S102 can be omitted.

In step S102, at timing of "i = 2" and subsequent timings, the CPU selects whether to perform read-out based on a count value read out last time by the read-out processing. The count value read out last time refers to, in other words, the latest count value out of count values which are read out at a plurality of non-destructive read-out timings set during an accumulation period.

In step S102 at timing of "i = 2" and subsequent timings, the CPU determines whether to perform read-out processing based on whether the count value read out last time is greater than or equal to a predetermined threshold value or whether the count value read out last time is less than or equal to a predetermined threshold value. For example, in a case where the count value read out last time is greater than or equal to a predetermined threshold value, the CPU determines not to perform read-out processing. In other words, in a case where the count value read out last time is less than the predetermined threshold value, the CPU determines to perform read-out processing.

This causes read-out processing to end at timing at which the count value has reached a desired value (predetermined threshold value). Thus, the CPU selects, from among a plurality of timings available for performing read-out processing, as timing at which not to perform read-out of a count value, timing later than the timing at which a count value read out by the read-out circuit 112 becomes greater than or equal to or less than or equal to a predetermined threshold value. This is performed for every frame, and the predetermined threshold value can be varied for every frame.

Since, by selecting timing at which not to perform read-out of a count value based on a count value read out by the read-out circuit 112, read-out processing is not performed at timing after the desired count value has been reached, read-out processing is not performed more than necessary. Accordingly, it is possible to not only reduce power consumption but also acquire an image with a desired brightness (count value).

Up to this point, selecting timing at which not to perform read-out processing based on a count value read out in an accumulation period for one frame has been described. Next, a method of selecting timing at which not to perform read-out processing based on a comparison between respective count values read out in accumulation periods for at least two frames is described.

In this method, first, the CPU performs read-out processing at all of the read-out timings with respect to accumulation periods for two frames (equivalent to the frame 1 and the frame 2 illustrated in FIG. 7). Then, with regard to a comparison between accumulation periods for two frames, the CPU compares count values read out from frames having the same accumulation period (for example, the frame 1_1 and the frame 2_1) with each other and then calculates a change in the count values.

Next, the CPU identifies timing (a frame) at which a change in the calculated count value is within a predetermined range, and selects timing later than the identified timing as timing at which not to perform read-out of a count value. For example, in a case where the amount of change of count values read out in the frame 1_1 and the frame 2_1 is less than or equal to a predetermined amount, the CPU determines not to perform read-out processing at timings subsequent to the frame 1_1 and the frame 2_1.

If, in accumulation periods for at least two frames, there is no change in the respective count values read out therein, it is estimated that there is also no change in images which are generated based on the count values. Therefore, since, by omitting read-out processing on images between which there is no change, unnecessary read-out processing is not performed, it is possible to reduce power consumption.

Furthermore, here, timing at which not to perform read-out processing is selected based on a count value or a change in count values, but can be selected based on an image which is generated by the image processing unit 603 (generation unit) from the read-out count value. For example, the CPU selects timing at which not to perform read-out processing based on the luminance of an image or a change in the luminance. Specifically, the CPU determines whether an image in the first accumulation period has reached a desired luminance or the CPU calculates a change in luminance of images in the first accumulation period in the respective accumulation periods for at least two frames and determines whether the change in luminance is within a predetermined range. Then, in a case where the desired luminance has been reached or the change in luminance of images is within the predetermined range, the CPU selects timing subsequent to the first accumulation period as timing at which not to perform read-out processing.

In this way, performing selection of timing at which not to perform read-out processing based on not a count value but an actually generated image enables reducing power consumption while surely obtaining a desired image.

Besides, as the method of selecting timing at which not to perform read-out processing based on an image, there is a method of performing selection based on a change in scene. In this method, the CPU detects a change in scene between at least two scenes by a scene detection unit (not illustrated) and selects timing at which not to perform read-out processing based on whether a change in scene has been detected.

More specifically, in a case where no change in scene between two frames is detected, the CPU selects timing at which not to perform read-out of a count value, in such a way as to decrease the number of times of reading out count values in an accumulation period for one frame. Since no change in scene being detected indicates no large change occurring between images, in one embodiment, power consumption is actively reduced by decreasing timings at which to read out count values in an accumulation period for one frame.

On the other hand, in a case where a change in scene between two frames has been detected, the CPU selects timing at which to perform read-out of a count value in such a way as to increase the number of times of reading out count values in an accumulation period for one frame. Since, in a case where a change in scene has been detected, the possibility that, for example, control of, for example, focus or exposure or additional recognition processing becomes necessary is high, increasing the number of times of read-out of count values facilitates obtaining effects of various control operations or recognition processing. In this way, controlling the number of times count values are read out (i.e., timing at which read-out is skipped) based on the scene allow advantages of non-destructive read-out to be obtained while reducing power consumption.

The above-described method of selecting timing at which not to perform read-out of a count value can be implemented by setting whether to perform read-out processing with respect to each of a plurality of timings "i" (corresponding to the value of "i" in FIG. 9) for read-out in an accumulation period. On the other hand, selecting timing at which not to perform read-out processing can also be performed by setting the variable skipReadNum such as that illustrated in FIG. 17. In that case, the CPU only needs to set the value of the variable skipReadNum based on, for example, a count value, a change in count values, an image, or a change in scenes. For example, the method of selection that is based on a count value can be implemented by, for example, setting a remaining number of times of read-out (a value obtained by subtracting the current value of the variable "i" from the threshold value i_th) to the variable skipReadNum if the count value has become greater than or equal to a predetermined threshold value.

### Second Embodiment

In a second embodiment, a case where the CPU performs read-out of a signal in the first accumulation period from the sensor (photoelectric conversion element 100) but does not perform processing for calculating control information from the read-out image is described. Furthermore, the apparatus configuration of a photoelectric conversion apparatus and the content of read-out processing are similar to those in the first embodiment and are, therefore, omitted from description here.

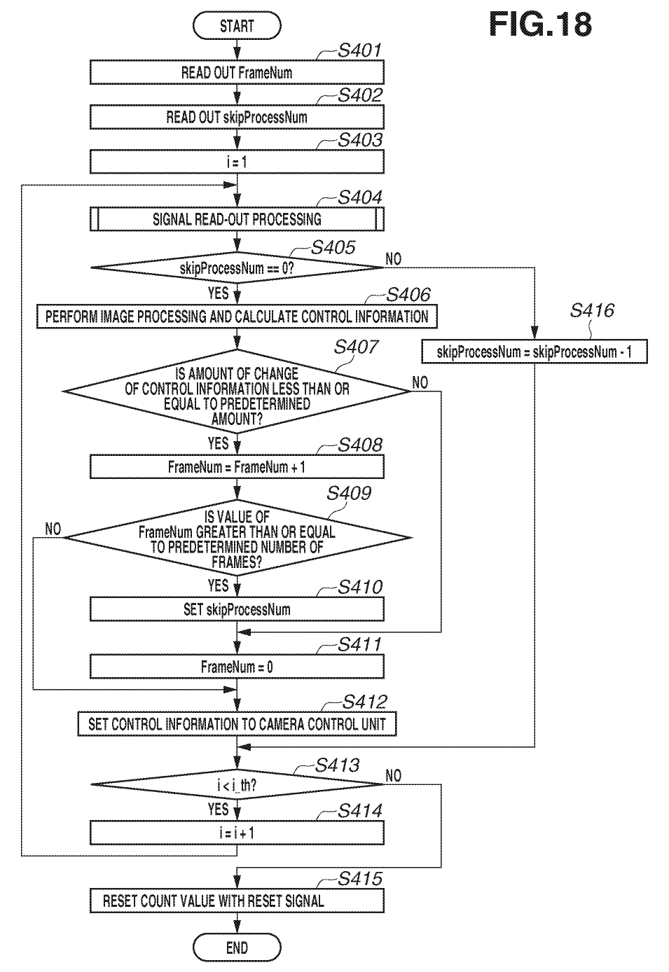

FIG. 18 is a flowchart illustrating an operation of the photoelectric conversion apparatus according to the second embodiment. Unlike the first embodiment, the photoelectric conversion apparatus according to the second embodiment is characterized in that the CPU causes the read-out circuit 112 to perform read-out processing at all of the timings. On the other hand, the CPU selects a count value on which not to perform image processing by the image processing unit 603 from a plurality of count values read out by the read-out circuit 112.

In step S401, the CPU reads out a variable FrameNum which has information about the number of frames in which the amount of change between control information calculated from a signal in the first accumulation period and the previously calculated control information has continued to be less than or equal to a predetermined amount. In step S402, the CPU reads out a variable skipProcessNum which indicates the number of frames in which not to perform image processing on an image signal (count value) read out in the first accumulation period. Here, it is assumed that, after being reset to "0" by initialization at the time of power-on, the variable FrameNum and the variable skipProcessNum have, stored therein, respective updated values by various processing operations.

Next, in step S403, the CPU performs setting of "i = 1". In step S404, the CPU performs read-out processing. The read-out processing to be performed in step S404 is similar to the above-described processing in the flowchart of FIG. 10. Upon completion of the read-out processing, the CPU advances the processing to step S405.

In step S405, the CPU determines whether the variable skipProcessNum is equal to "0" (skipProcessNum == 0), and, if it is determined that the variable skipProcessNum is equal to "0 (YES in step S405), the CPU advances the processing to step S406. If it is determined that the variable skipProcessNum is not equal to "0" (NO in step S405), the CPU advances the processing to step S416.

In step S406, the CPU performs image processing by the image processing unit 603 based on a signal (count value) read out in step S404. The image processing can include, in addition to processing for performing development processing on an image by correcting the non-linearity of a read-out count value, for example, post-development image processing such as white balance correction processing.

Moreover, in step S406, the CPU calculates control information to be used by the camera control unit 605, and then stores the calculated control information. The CPU can calculate the control information based on an image obtained by the image processing unit 603 performing image processing or can calculate the control information based on an image obtained before the image processing unit 603 performs image processing thereon.

Next, in step S407, the CPU compares the control information calculated in the previous or more previous frame and the control information calculated in step S406 with each other and determines whether the amount of change therebetween is less than or equal to a predetermined amount. If, in step S407, it is determined that the amount of change in the control information is less than or equal to the predetermined amount (YES in step S407), then in step S408, the CPU increments the variable FrameNum.

Next, in step S409, the CPU determines whether the value of the variable FrameNum is greater than or equal to a predetermined number of frames. If it is determined that the value of the variable FrameNum is greater than or equal to the predetermined number of frames (YES in step S409), then in step S410, the CPU sets the variable skipProcessNum. Next, in step S411, the CPU initializes the value of the variable FrameNum to "0". After that, in step S412, the CPU sets the control information set in step S406 to the camera control unit 605.

If, in step S407, it is determined that the amount of change in the control information is neither less than nor equal to the predetermined amount (NO in step S407), then in step S411, the CPU performs setting of "FrameNum = 0". If, in step S409, it is determined that the value of the variable FrameNum is neither greater than nor equal to the predetermined number of frames (NO in step S409), then in step S412, the CPU sets the control information to the camera control unit 605.

In step S413, the CPU determines whether "i < i_th". The threshold value i_th is similar to that described in the first embodiment and is, therefore, omitted from description here. If the result of determination in step S413 is Yes (YES in step S413), then in step S414, the CPU increments the variable "i" to perform setting of "i = i + 1", and then returns the processing to step S404. This operation corresponds to an operation which starts performing reading-out at next time T12 or T22.

If, in step S405, it is determined that the variable skipProcessNum, which indicates the number of frames in which not to perform image processing on an image signal read out in the first accumulation period, is not "0" (NO in step S405), then in step S416, the CPU decrements the variable skipProcessNum, and then advances the processing to step S413.

If the result of determination in step S413 is No (NO in step S413), this means that read-out at time T12 or T22 has been completed, then in step S415, the CPU resets the counter circuit 211 with the reset signal. This operation corresponds to a reset operation which is performed by the counter circuit 211 at time T12 or T22 illustrated in FIG. 7. In the above-described way, it is possible to sequentially read out signals accumulated in the photoelectric conversion element 100.

As described above, in the second embodiment, the CPU performs read-out processing from the sensor (photoelectric conversion element 100), but selects a count value on which not to perform a process for generating an image by performing predetermined image processing (from which not to generate an image), from among a plurality of count values read out by read-out processing.

This enables a power consumption reduction effect in cases where the power consumption of the image processing unit 603 is large. Furthermore, the CPU can be configured to, without skipping processing for developing from a count value among processing operations performed by the image processing unit 603, skip only a process for post-development image processing and calculate control information based on a simply developed image.

Moreover, a configuration in which the image processing unit 603 is provided with a neural network for calculating control information and the neural network receives, as inputs, signals generated in the first accumulation period and the second accumulation period and calculates control information based on the received signals can be employed. Performing learning with use of the signals generated in the first accumulation period and the second accumulation period enables increasing the accuracy of calculating control information.

Besides, by skipping only calculation of control information in a similar process, it is also possible to obtain an advantageous effect of reducing arithmetic operation cost for calculating control information or power consumption for calculating control information. Particularly, in the case of performing calculation of control information using a neural network as mentioned above, an advantageous effect of reducing arithmetic operation cost or power consumption for calculating control information may be large.

Thus, in a case where the CPU supplies to the camera control unit 605 (correction unit) correction information (control information) concerning an image based on a count value read out in the first accumulation period, the CPU selects a count value from which not to calculate correction information from among a plurality of count values read out by the read-out circuit 112.

Furthermore, the selection of a count value from which not to generate an image by performing predetermined processing and the selection of a count value from which not to calculate correction information can be combined with the method of selecting timing at which not to perform read-out processing described above in the first embodiment. Thus, the CPU can select a count value on which not to perform image processing (or from which not to generate an image) or from which not to calculate correction information, based on a count value, a change in count values, or a change in images or scenes.

According to an aspect of the disclosure, it is possible to reduce electric power which is consumed by read-out processing or development processing.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-066286 filed April 14, 2025, which is hereby incorporated by reference herein in its entirety.

What is claimed is:

1. An apparatus comprising:
a conversion portion configured to generate a detection signal by avalanche multiplication;
a counter circuit configured to count a signal that is based on the detection signal output from the conversion portion;
a read-out circuit configured to read out a count value obtained by the counter circuit, the read-out circuit being capable of reading out the count value at a plurality of timings in an accumulation period for one frame of the conversion portion;
a processor; and
a memory storing a program which, when executed by the processor, causes the apparatus to select, from the plurality of timings, timing at which not to perform read-out of the count value.

2. The apparatus according to claim 1, wherein the program further causes the apparatus to select timing at which not to perform read-out of the count value, based on the count value read out by the read-out circuit.

3. The apparatus according to claim 2, wherein the program further causes the apparatus to select, from the plurality of timings, as timing at which not to perform read-out of the count value, timing later than timing at which the count value read out by the read-out circuit becomes greater than or equal to or less than or equal to a predetermined threshold value.

4. The apparatus according to claim 1, wherein, in a comparison between the count values read out in respective accumulation periods for at least two frames, the program further causes the apparatus to identify timing at which a change in the count values becomes within a predetermined range, and select timing later than the identified timing as timing at which not to perform read-out of the count value.

5. The apparatus according to claim 1, further comprising a generation unit configured to generate an image based on the count value read out by the read-out circuit,
wherein the program further causes the apparatus to select timing at which not to perform read-out of the count value, based on the image.

6. The apparatus according to claim 5, further comprising a detection unit configured to detect a change in scene based on the image,
wherein, in a case where the change in scene is not detected by the detection unit in the accumulation period, the program further causes the apparatus to select timing at which not to perform read-out of the count value, in such a way as to decrease a number of times of detecting the count value.

7. The apparatus according to claim 5, further comprising a detection unit configured to detect a change in scene based on the image,
wherein, in a case where the change in scene has been detected by the detection unit in the accumulation period, the program further causes the apparatus to select timing at which to perform read-out of the count value, in such a way as to increase a number of times of detecting the count value.

8. The apparatus according to claim 1, further comprising a control unit configured to generate control information for the apparatus based on the count value read out by the read-out circuit,
wherein the program further causes the apparatus to select timing at which not to perform read-out of the count value, based on the control information.

9. The apparatus according to claim 5, further comprising a control unit configured to generate control information for the apparatus based on the image generated by the generation unit,
wherein the program further causes the apparatus to select timing at which not to perform read-out of the count value, based on the control information.

10. The apparatus according to claim 8, wherein the program further causes the apparatus to select timing at which not to perform read-out of the count value, based on a change in the control information generated in accumulation periods for at least two frames.

11. The apparatus according to claim 9, wherein the program further causes the apparatus to select timing at which not to perform read-out of the count value, based on a change in the control information generated in accumulation periods for at least two frames.

12. The apparatus according to claim 10, wherein, in a case where the change in the control information is within a predetermined range, the program further causes the apparatus to select timing at which not to perform read-out of the count value, in such a way as to decrease a number of times of read-out of the count value.

13. The apparatus according to claim 10, wherein, in a case where the change in the control information is outside a predetermined range, the program further causes the apparatus to select timing at which to perform read-out of the count value, in such a way as to increase a number of times of read-out of the count value.

14. The apparatus according to claim 8, wherein the control information is generated based on a count value read out in an accumulation period shorter than the accumulation period for one frame, and includes correction information for an image captured in the shorter accumulation period.

15. The apparatus according to claim 9, wherein the control information is generated based on a count value read out in an accumulation period shorter than the accumulation period for one frame, and includes correction information for an image captured in the shorter accumulation period.

16. The apparatus according to claim 8, wherein the control information is correction information concerning exposure or focus.

17. The apparatus according to claim 9, wherein the control information is correction information concerning exposure or focus.

18. An apparatus comprising:
a conversion portion configured to generate a detection signal by avalanche multiplication;
a counter circuit configured to count a signal that is based on the detection signal output from the conversion portion;
a read-out circuit configured to read out a count value obtained by the counter circuit in an accumulation period for one frame of the conversion portion, the read-out circuit being capable of reading out the count value at a plurality of timings in the accumulation period;
a generation unit configured to generate an image by performing predetermined processing based on the count value read out by the read-out circuit;
a processor; and
a memory storing a program which, when executed by the processor, causes the apparatus to select, from the count values read out at the plurality of timings, the count value from which not to generate the image.

19. An apparatus comprising:
a conversion portion configured to generate a detection signal by avalanche multiplication;
a counter circuit configured to count a signal that is based on the detection signal output from the conversion portion;
a read-out circuit configured to read out a count value obtained by the counter circuit in an accumulation period for one frame of the conversion portion, the read-out circuit being capable of reading out the count value at a plurality of timings in the accumulation period;
a generation unit configured to generate an image based on the count value;
a correction unit configured to calculate correction information concerning the image based on the count value read out in an accumulation period shorter than the accumulation period for one frame out of the count values read out at the plurality of timings;
a processor; and
a memory storing a program which, when executed by the processor, causes the apparatus to select, from the count values read out at the plurality of timings, the count value from which not to calculate the correction information.
